(19) United States
(12) Patent Application Publication
(10) Pub. No.: US 2003/0054183 A1
(43) Pub. Date: Mar. 20, 2003

(54) MIR-wipes

(76) Inventors: Robert Forrest, South Windsor, CT (US); Elizabeth Forrest, South Windsor, CT (US)

Correspondence Address: ROBERT FORREST, 1010 STRONG ROAD, SOUTH WINDSOR, CT, 06074, US

(21) Appl. No.: 10/227,656

(22) Filed: Nov. 13, 2002

Related U.S. Application Data
(60) Provisional application No. 60/315,248, filed on Aug. 27, 2001.

(51) Int. Cl. B32B 15/10

(52) U.S. Cl. 428/464

(57) ABSTRACT

A reflective napkin that has a reflective layer such as a Mylar material and a underlying layer of an absorbent material. This product can be used when a mirror is not handy or convenient and a person needs to see their reflection. The mirrored part can be all of one side or a portion of one side. The absorbent part can be all of one side or a portion of one side. Mir wipes can be a disposable type of napkin and be pliable (able to bend or fold) in nature.

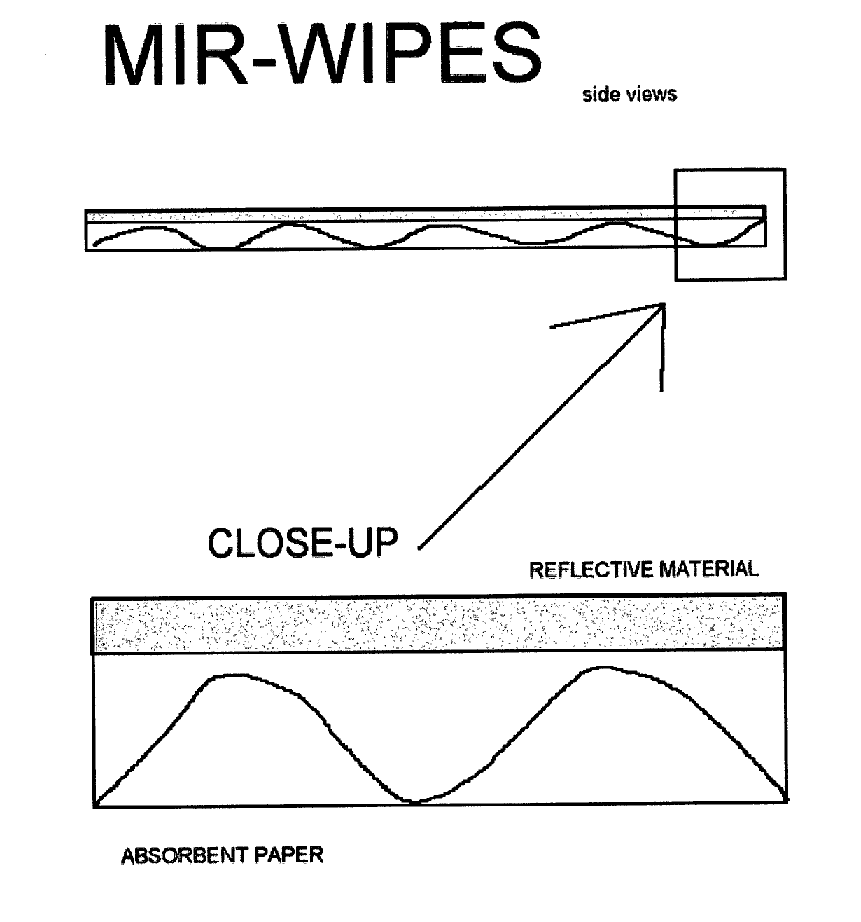

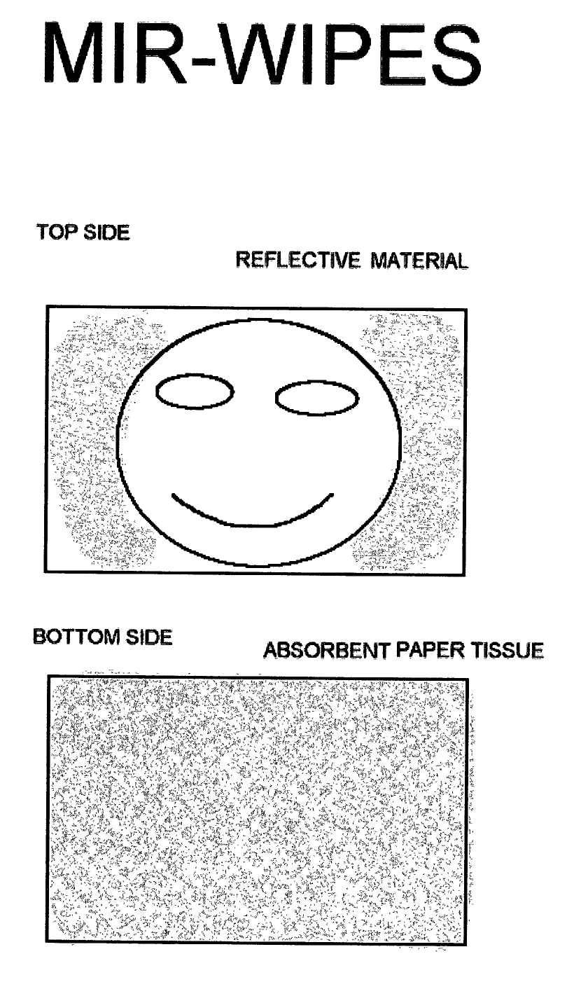

### DESCRIPTION

A paper tissue or napkin that has a reflective side. One side is a mirrored surface the other side is the cleaning surface.

### USES OF MIR-WIPES

When there are no restroom facilities around and you need a mirror.

for picnics.

for weddings

in place of a compact mirror

is a convience and time saver

in general Mir-wipes are effective as a cleaning accessary when mirrors are not conveniently located.

What I claim as my invention is

1. A new and unique type of paper napkin with many uses.
One part of the napkin has a reflective surface for use as a mirror. Said surface can be pliable and will reflect an image from it.
The rest of the napkin is made up of an absorbent material.

2. When a person needs to see their reflection and no mirror is handy they can use this product to help clean their face up.

3. This napkin can be all of one side or a portion of one side. The surface can be of Mylar or some type of reflective plastic or aluminum.

4. The absorbent portion can be made of standard napkin material. (varying paper weights)
